(19) United States
(12) Patent Application Publication
(10) Pub. No.: US 2023/0214716 A1
(43) Pub. Date: Jul. 6, 2023

(54) LEARNING DEVICE

(71) Applicant: NTT DOCOMO, INC., Chiyoda-ku (JP)

(72) Inventors: Noriaki HIROKAWA, Chiyoda-ku (JP); Yoshitaka INOUE, Chiyoda-ku (JP); Kenji SHINODA, Chiyoda-ku (JP); Manami KAWASAKI, Chiyoda-ku (JP); Yusuke FUKAZAWA, Chiyoda-ku (JP)

(73) Assignee: NTT DOCOMO, INC., Chiyoda-ku (JP)

(21) Appl. No.: 18/000,844

(22) PCT Filed: May 13, 2021
(86) PCT No.: PCT/JP2021/018266

§ 371 Date: Dec. 6, 2022

(30) Foreign Application Priority Data
Jun. 8, 2020 (JP) 2020-099234

(51) Int. Cl. G06N 20/00

(52) U.S. Cl. CPC G06N 20/00

(57) ABSTRACT

A learning apparatus 10 of one embodiment includes an acquisition unit 11 for acquiring action history data indicating action history for each of a plurality of users, and a learning unit 13 for learning parameter groups PC, C included in a predictive model M for predicting an action of each of the plurality of users by using the action history data as training data. The parameter group PC is a parameter group related to a membership rate of each user for each of a plurality of clusters. The parameter group C is a parameter group related to an action tendency of each cluster for each of a plurality of actions.

### TECHNICAL FIELD

One aspect of the present invention relates to a learning apparatus.

### BACKGROUND ART

There is known a mechanism for calculating a probability (selection probability) that a specific user takes a predetermined action (for example, browsing, purchasing, or evaluating a predetermined product, or visiting or evaluating a predetermined location) based on action history data for the specific user (for example, see Patent Document 1).

### CITATION LIST

### Patent Document

[Patent Document 1] Japanese Unexamined Patent Publication No. 2016-103107

### SUMMARY OF INVENTION

### Technical Problem

When behavior prediction of a plurality of users is performed by applying the above-described mechanism, it is necessary to calculate (learn) a probability that each action is performed for each user. In this case, the number of parameters to be learned (that is, the number of users×the number of actions) are large. As a result, the amount of calculation for learning becomes very large, and there is a possibility that the necessary calculation resources become enormous.

An object of one aspect of the present invention is to provide a learning apparatus capable of effectively reducing calculation resources necessary for learning a predictive model that predicts actions of a plurality of users.

### Solution to Problem

A learning apparatus according to one aspect of the present invention includes: an acquisition unit configured to acquire action history data indicating action history for each of a plurality of users; and a learning unit configured to learn a first parameter group and a second parameter group included in a predictive model for predicting an action of each of the plurality of users by using the action history data as training data. The first parameter group is a parameter group related to a membership rate of each user for each of a plurality of clusters. The second parameter group is a parameter group related to an action tendency of each cluster for each of a plurality of actions.

A learning apparatus according to one aspect of the present invention learns a first parameter group indicating a relationship between users and clusters and a second parameter group indicating a relationship between the clusters and actions, instead of directly learning a probability that each of a plurality of users performs each of a plurality of actions (i.e., a correspondence relationship between the users and the actions). Here, a simplified example of a case where the number of users is ten million, the number of actions is ten thousand, and the number of clusters is 100 is shown below. In this case, in the former case (i.e., in case for directly learning a probability that each of a plurality of users performs each of a plurality of actions), the number of parameters to be learned is “100,000,000,000 (=the number of users (10,000,000)×the number of actions (10,000))”. On the other hand, in the latter case (i.e., in case for learning the first and second parameters), the number of parameters to be learned is “1,001,000,000 (=the number of users (10,000,000)×the number of clusters (100)+the number of clusters (100)×the number of actions (10,000))”. As described above, according to the learning apparatus according to one aspect of the present invention, the number of parameters to be learned can be effectively reduced. As a result, it is possible to effectively reduce calculation resources necessary for learning the predictive model.

### Advantageous Effects of Invention

According to one aspect of the present invention, it is possible to provide a learning apparatus capable of effectively reducing calculation resources necessary for learning a predictive model that predicts actions of a plurality of users.

### BRIEF DESCRIPTION OF DRAWINGS

FIG. 1 is a diagram illustrating a functional configuration of a learning apparatus according to an embodiment.

FIG. 2 is a diagram illustrating an example of action history data.

FIG. 3 is a diagram illustrating an example of a predictive model.

FIG. 4 is a diagram illustrating another example of a predictive model.

FIG. 5 is a diagram schematically illustrating a relationship between a parameter group P related to an action tendency of each user, a parameter group PC related to a cluster membership rate, and a parameter group C related to an action tendency of each cluster.

(A) of FIG. 6 is a diagram illustrating an example of a parameter group PC related to a cluster membership rate, and (B) of FIG. 6 is a diagram illustrating an example of a parameter group C related to an action tendency of each cluster.

FIG. 7 is a diagram for explaining learning processing.

FIG. 8 is a diagram schematically showing a first learning process.

FIG. 9 is a diagram schematically showing a second learning process.

FIG. 10 is a flowchart showing an example of the operation of the learning apparatus.

FIG. 11 is a flowchart illustrating an example of a learning process when the number of clusters is variable.

FIG. 12 is a diagram illustrating an example of a hardware configuration of the learning apparatus.

### DESCRIPTION OF EMBODIMENTS

Hereinafter, one embodiment of the present invention will be described in detail with reference to the attached drawings. In description of the drawings, the same reference signs will be assigned to the same elements or elements corresponding to each other, and duplicate description thereof will be omitted.

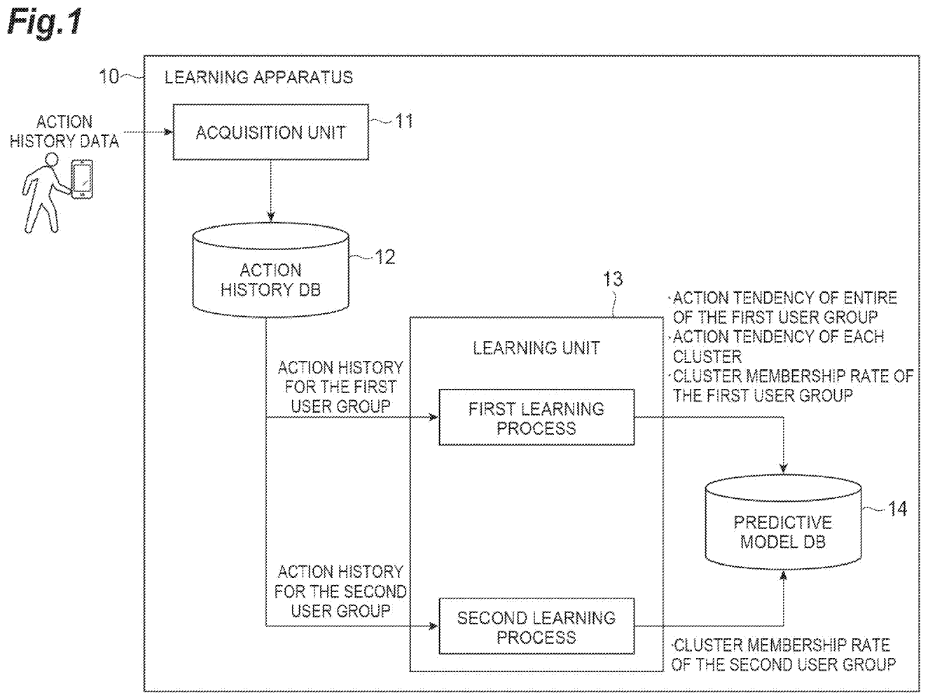

FIG. 1 is a diagram illustrating a functional configuration of a learning apparatus 10 according to an embodiment. The learning apparatus 10 is an apparatus that learns a predictive model (probability model) for predicting an action of each user by using action history data indicating an action history for each of a plurality of users as training data. The learning apparatus 10 may be configured by a single computer apparatus (for example, a server apparatus or the like), or may be configured by a plurality of computer apparatuses that are communicably connected to each other. As illustrated in FIG. 1, the learning apparatus 10 includes an acquisition unit 11, an action history DB 12, a learning unit 13, and a predictive model DB 14.

The acquisition unit 11 acquires action history data for each of a plurality of users. The acquisition unit 11 acquires, for example, action history data on actions performed by each user in a predetermined target period (for example, a period from “2019/11/1” to “2019/11/31”). The action history data for each of the plurality of users acquired by the acquisition unit 11 are stored in the action history DB 12 which is a database storing the action history data.

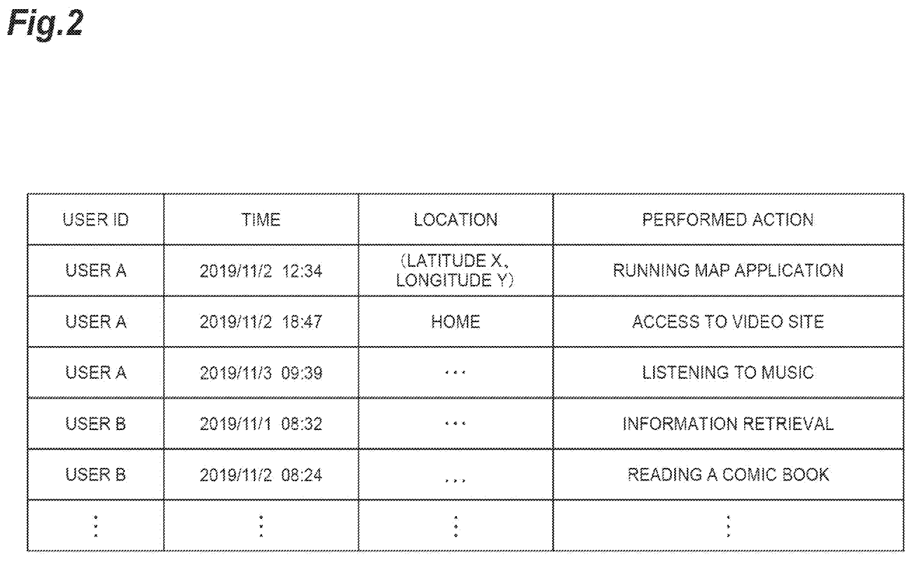

FIG. 2 is a diagram illustrating an example of action history data. As an example, the action history data includes a plurality of records defined for each action performed by the user. Each record is information in which identification information (user ID) for identifying a user, time information indicating a time, location information indicating a location, and information indicating an action performed by a user specified by the user ID at the time and the location are associated with each other.

The time information may be represented by date and time (for example, information in units of minutes represented by year, month, day, hour, and minute), for example. However, the granularity of the time information is not limited to the above, and may be, for example, an hour unit, a day unit, or the like.

The location information may be represented by, for example, latitude and longitude. In addition, the location information may be represented by a location type such as “home”, “company”, “station”, or “convenience store”. The location information may be information indicating a relatively wide area such as “Tokyo” or may be information (identifier) for identifying a regional mesh (for example, 500 m mesh).

The action may include various user actions such as an operation on a user terminal such as a smartphone (for example, use of a specific application), a visit to a specific location (for example, a store), and daily activities (for example, specific activities such as running, sleeping, and eating). The type of action acquired as the action history data may be defined in advance, for example, at the design stage of the predictive model. In the following, several methods for obtaining action history data are illustrated. However, the method by which the acquisition unit 11 acquires the action history data for each user is not limited to the specific method exemplified below.

(First Example of Acquiring Action History Data)

The acquisition unit 11 may acquire an operation history of a user terminal possessed by each user as the action history data. For example, when the user operates the user terminal to use a specific application (for example, a route search application, an application for listening to music, or a moving image viewing application), the acquisition unit 11 may acquire a use history of the application (for example, information in which time, location, and used application are associated with each other) as the action history data. At this time, the acquisition unit 11 may acquire, for example, position information of the user terminal (for example, information of latitude and longitude obtained by base station positioning, GPS positioning, or the like) as the location information. Alternatively, the acquisition unit 11 may specify a location (for example, a specific store, an area such as “Tokyo”, a regional mesh, or the like) as described above from the position information (latitude and longitude) of the user terminal using information indicating a correspondence relationship between latitude and longitude and the location (for example, a store or the like), and acquire the location information indicating the specified location.

(Second Example of Acquiring Action History Data)

The acquisition unit 11 may acquire a history of the position information of the user terminal and estimate a location visited by the user from the history. Then, when it is estimated that the user has visited a specific location (for example, a location registered in advance as a target for acquiring an action history), the acquisition unit 11 may acquire action history data indicating that the user has visited the specific location (that is, action history data in which the visit to the specific location is registered as an “performed action”).

(Third Example of Acquiring Action History Data)

The acquisition unit 11 may acquire, as action history data, information related to an action history (for example, information indicating when, where, and what the user has performed) explicitly input by the user operating the user terminal.

(Fourth Example of Acquiring Action History Data)

When the user makes a payment using a credit card, a point card, or the like in a store or the like, the acquisition unit 11 may acquire action history data indicating that the payment process is an “performed action”. In this case, the acquisition unit 11 can acquire action history data indicating when, where (in which store) an action (settlement process) has been executed by acquiring the settlement history of the user from a store or the like, for example.

(Fifth Example of Acquiring Action History Data)

The acquisition unit 11 may acquire the action history data limited to a specific action. As an example, a case in which attention is paid to purchase behavior of a user will be described. In this case, the acquisition unit 11 may acquire only the history of the purchase behavior (action) of the user as the action history data. In this case, the action history DB 12 stores the action history data indicating when and in which store a purchase action was performed for each user. From the action history data accumulated in this manner, it is possible to grasp the tendency of the purchase behavior of the user. Examples of the tendency of the purchase behavior include a tendency of a location or time in which a probability of performing the purchase behavior is high, a tendency of a time interval between purchase behaviors that are continuous with each other, and a tendency in which a probability of shopping in a certain store A and then shopping in another store B is high.

The learning unit 13 learns the predictive model by using the action history data acquired by the acquisition unit 11 (that is, the action history data stored in the action history DB 12) as training data. More specifically, the learning unit 13 learns a parameter group included in the predictive model.

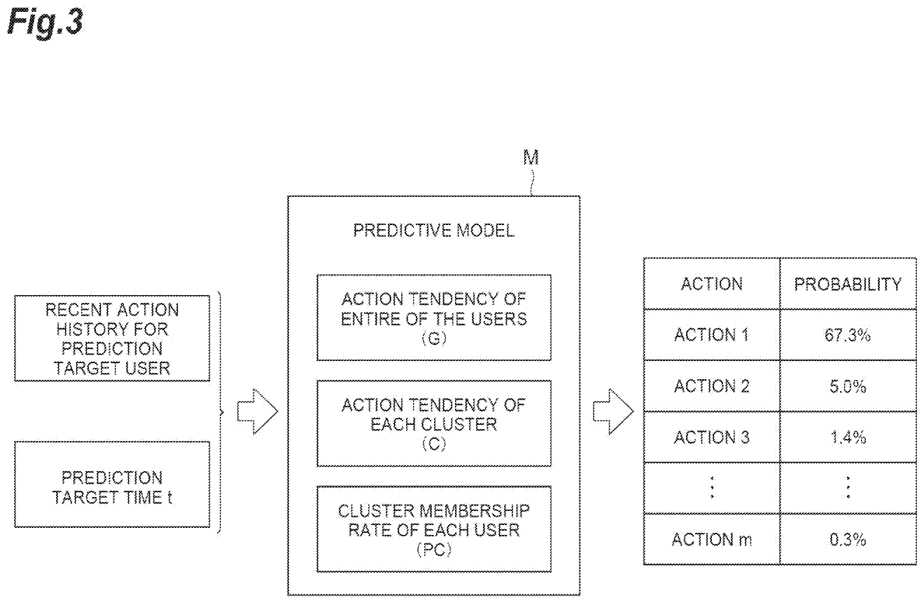

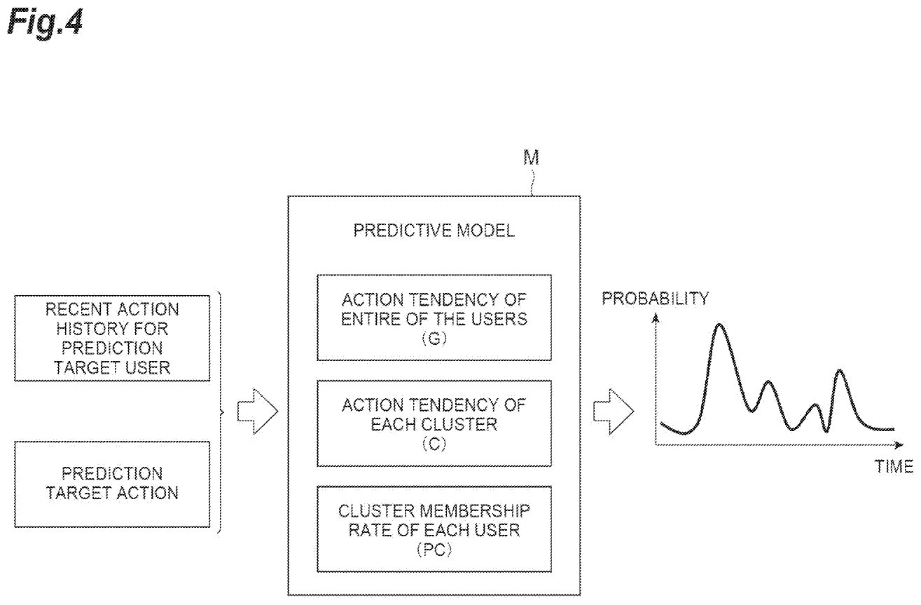

The predictive model M learned by the learning unit 13 will be described with reference to FIGS. 3 and 4 before explaining the details of the learning processing by the learning unit 13. The predictive model M is, for example, a machine learning model such as a neural network (multilayer neural network, hierarchical neural network, or the like) and a point process model. Maximum likelihood estimation, Bayesian estimation, or the like may be used as an algorithm for learning (parameter estimation) of the predictive model M. As shown in FIG. 3 or 4, the predictive model M includes parameter groups G, C, and PC as parameters learned by the learning unit 13 (learned parameters). The parameter group G (third parameter group) is a parameter group related to an action tendency of entire of a plurality of users. The parameter group C (second parameter group) is a parameter group related to an action tendency of each cluster. The parameter group PC (first parameter group) is a parameter group related to a cluster membership rate of each user. Details of each parameter group G, C, and PC will be described later.

In the example of FIG. 3, the predictive model M is given recent action history data for a prediction target user (for example, action history data in a most recent period of a predetermined length) and a prediction target time t as input data. The predictive model M outputs a probability that each of a plurality of predefined actions is performed by the prediction target user at the prediction target time t based on the parameter group G, the parameter group C, and the parameter group PC (parameter group related to the prediction target user). That is, the predictive model M applies the learned parameter groups G, C, and PC to the input data to execute a predetermined calculation, thereby outputting a probability that each action is performed. According to such predictive model M, it is possible to predict an action of the prediction target user at a future time point (prediction target time t).

In the example of FIG. 4, the predictive model M is given recent action history data for the prediction target user and information indicating the prediction target action as input data. The predictive model M outputs information in which the probability and time at which the prediction target action is performed by the prediction target user are associated with each other based on the parameter group G, the parameter group C, and the parameter group PC (parameter group related to the prediction target user). According to such predictive model M, it is possible to predict a future time point at which the prediction target user is likely (or not likely) to perform a specific action (prediction target action).

Note that the method of using the predictive model M shown in FIGS. 3 and 4 is an example, and data other than the input data shown in the above examples may be input to the predictive model M, or data other than the output result shown in the above examples may be output. The predictive model M may be configured to be compatible with a plurality of usage methods (for example, the usage methods illustrated in FIGS. 3 and 4 described above). That is, the predictive model M may operate as in the example illustrated in FIG. 3 when the recent action history data for the prediction target user and the prediction target time t are input, and may operate as in the example illustrated in FIG. 4 when the recent action history data for the prediction target user and information indicating the prediction target action are input.

(Parameter Group G)

Next, the parameter group G related to the action tendency of the entire users will be described. As an example, the parameter group G may include a plurality (n) of parameter groups G₁, . . . , Gₙ. The parameter group G may include the following parameter group as one of a plurality of parameter groups G₁, . . . , Gₙ.

(First Example of Parameter Group Included in Parameter Group G)

The parameter group G may include, for example, a parameter group indicating a correspondence relationship between actions and time. This parameter group holds, for each pair of a time point and an action, a parameter related to a probability that a certain action is performed at a certain time point. Here, the “parameter related to a probability” may be a value representing the probability itself, or may be a parameter (coefficient) used in a probability calculation expression (for example, refer to Expression 1 described later) defined in advance in the predictive model M (the same applies hereinafter). As an example, in a case where 10,000 actions are defined and 1,440 time points obtained by dividing one day (24 hours) in units of minutes are defined as the time, the parameter group includes 14,400,000 (=10,000×1,440) parameters. The parameter is, for example, a parameter indicating the magnitude of the probability (i.e., a parameter indicating that the larger the value, the higher the probability).

(Second Example of Parameter Group Included in Parameter Group G)

The parameter group G may include a parameter group indicating a relationship between actions. This parameter group holds, for each pair of two actions, a parameter relating to the probability that an arbitrary action B will be performed after an arbitrary action A has been performed. For example, when ten thousand actions are prepared, the parameter group includes ten million (=ten thousand ×ten thousand) parameters. The parameter may be, for example, a parameter indicating the degree of probability as in the first example described above, or may be a parameter corresponding to a period (expected value) from when the action A is performed to when the action B is performed. In the latter case, the larger the value of the parameter, the lower the probability that the action B is performed immediately after the action A has been performed.

The parameter group G (G₁, . . . , Gₙ) as described above may constitute a part of a probability calculation expression defined in advance for calculating an occurrence probability (execution probability) of each action. An example of the probability calculation expression is shown below.

P(Aₖ|user,time,location,history)=G₁(time)+G₂(location)+exp(G₃(time,location))+ . . . +log(Gₙ(time,history))+F(user) Equation 1:

In Equation 1, “Aₖ” is a variable indicating a specific action (for example, an action ID identifying the action). The “user” is a variable indicating a user (for example, a user ID identifying the user). The “time” is a variable indicating time (for example, information indicating date, hour, and minute). “location” is a variable indicating a location (for example, latitudes and longitudes, area ID indicating “Tokyo” as exemplified above, identifiers of “500 m mesh”, or the like). The “history” is a variable indicating recent action history data for the user (the user indicated by the variable “user”). The “history” represents, for example, the action history data (a plurality of records) illustrated in FIG. 2 by a variable-length array, a tensor format, or the like. The “P (Aₖ|user, time, location, history)” is a probability that a certain user (user indicated by the variable “user”) performs a certain action (action indicated by the variable “Aₖ”) in a location (location indicated by the variable “location”) at a certain time (time indicated by the variable “time”).

The predictive model M has, for example, a probability calculation expression represented by the above Equation 1 for each of a plurality of (m) actions defined in advance (actions A₁, . . . , Aₘ). That is, the predictive model M can be composed of expressions represented by the above Equation 1 for each action and learned parameter groups G, P C, and C used in the expressions.

“G₁(time)” on the right side of Equation 1 is a parameter related to the probability that the action Aₖ is performed at the time indicated by the variable “time”. Similarly, “G₂(location)” is a parameter related to the probability that the action Aₖ is performed at the location indicated by the variable “location”. “G₃(time, location)” is a parameter related to the probability that the action Aₖ is performed when the combination of the time indicated by the variable “time” and the location indicated by the variable “location” is realized. “Gₙ(time, history)” is a parameter related to the probability that the action Aₖ is performed at the time indicated by the variable “time” when the recent action history is the action history data indicated by the variable “history”. Like “G₃(time, location)” and “Gₙ(time, history)” in Equation 1, the parameter may be a parameter of an arbitrary function such as an exponential function (exp function), a logarithmic function (log function), or a trigonometric function (for example, sin, cos, or the like).

Note that the parameter group G indicating the tendency of the entire users described above is a parameter group commonly applied to each of a plurality of users, and thus does not have a different parameter for each variable “user” of Equation 1 above. In other words, the parameter group G alone cannot provide a prediction result reflecting user-specific features (individual differences). Therefore, the predictive model M has a parameter group (parameter groups C and PC) having a different parameter for each variable “user” in order to obtain a prediction result reflecting the feature of each user. “F (user)” in the above Equation 1 is a parameter group corresponding to the variable “user” in the parameter groups C and PC.

(Parameter Groups PC and C)

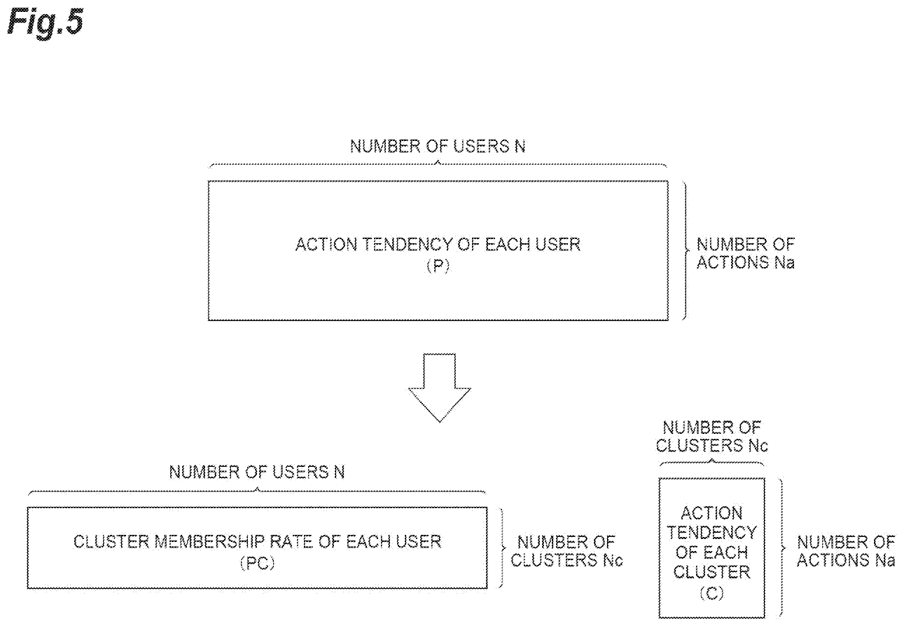

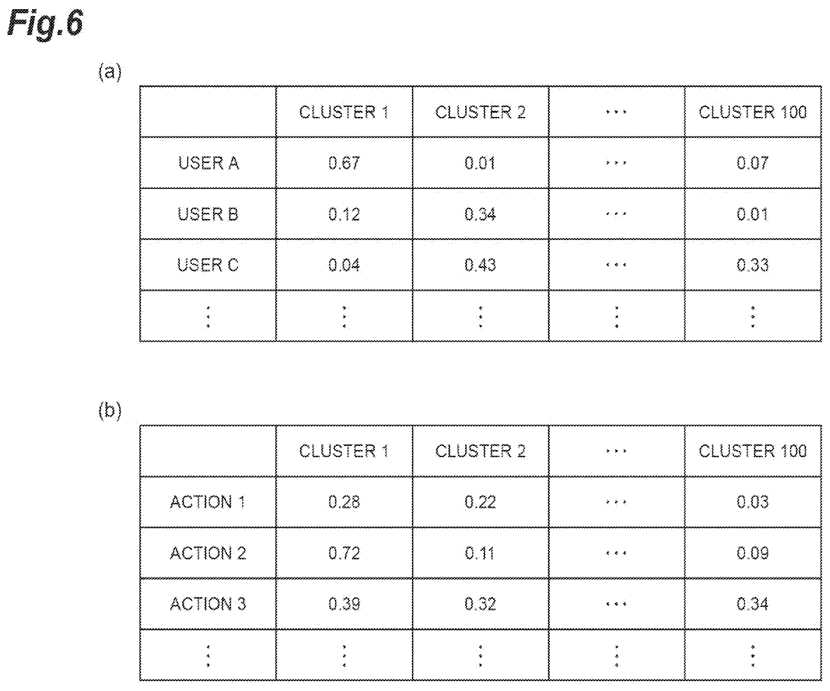

Next, parameter groups PC and C will be described. First, with reference to FIG. 5, an effect of using two parameter groups decomposed into parameter groups PC and C as parameters indicating an action tendency of each user will be described. As shown in FIG. 5, as a method of obtaining a prediction result reflecting a feature of each user, it is conceivable to learn a parameter group P that directly defines a correspondence relationship between users and actions (for example, a parameter group that holds a degree of tendency of each user performing each action). However, in this method, when the number of users is represented by N and the number of actions is represented by Na, it is necessary to learn parameters of the number of “N×Na”. For example, when “N=10,000,000 and Na=10,000”, the number of parameters included in the parameter group P is 100,000,000,000 (=10,000,000×10,000). When the number of parameters to be learned becomes enormous as described above, the calculation resources necessary for the learning process also become enormous, and it may be difficult to complete the learning process in a realistic time.

Therefore, in the present embodiment, instead of using the parameter group P described above, a parameter group C related to action tendency of each cluster and a parameter group PC related to cluster membership rate of each user are used. In this case, it is possible to roughly grasp the action tendency of each user via the cluster from the information of the parameter group C and the parameter group PC. Here, the number of clusters Nc is set to be smaller than the number of actions Na.

(A) of FIG. 6 shows an example of parameter group C in the case of “Nc=100”. The parameter group C has parameters (“N×Nc” parameters) defined for each pair of a user and a cluster. The parameter group C may be expressed in matrix form. A parameter corresponding to each element of the matrix illustrated in (A) of FIG. 6 indicates a membership rate of the user with respect to the cluster (that is, a degree to which the user fits the cluster). As an example, a larger parameter value indicates a larger degree to which the user fits into the cluster. In this example, the membership rate of the user A with respect to the cluster 1 is “0.67”. That is, this indicates that the degree to which the user A applies to the action tendency of the cluster 1 is “0.67”.

(B) of FIG. 6 shows an example of parameter group PC in the case of “Nc=100”. The parameter group PC includes parameters (“Nc×Na” parameters) defined for each pair of a cluster and an action. The parameter group PC may be expressed in a matrix form. A parameter corresponding to each element of the matrix illustrated in (B) of FIG. 6 indicates a tendency of a cluster with respect to an action. For example, the parameter indicates the degree of probability (or tendency) that a cluster (a user belonging to the cluster) performs an action. That is, a larger parameter value indicates a higher probability that the cluster (the user belonging to the cluster) performs the action. In this example, the probability that the cluster 1 (the user belonging to the cluster 1) performs the action 1 is “0.28”.

In the example of (B) of FIG. 6, the parameter group PC includes only parameters related to one pattern (that is, a general tendency common to all time zones), but the parameter group PC may include parameter groups as illustrated in (B) of FIG. 6 for each of a plurality of patterns (for example, four time zones such as morning, daytime, evening, and night). In this case, “F(user)” in the probability calculation expression of Equation 1 is rewritten as “F(user, time)”. In this embodiment, in order to simplify the description, it is assumed that the parameter group PC includes only one pattern of parameter group shown in (B) of FIG. 6.

In this way, by using parameter groups C and PC instead of parameter group P, the number of parameters to be learned can be reduced. To be specific, with respect to the number of parameters “N×Na” of the parameter group P, the number of parameters obtained by combining the parameter groups C and PC is “N×Nc+Nc×Na”. Therefore, by making the number of clusters Nc sufficiently smaller than the number of actions Na, the number of parameters can be greatly reduced. For example, when “N=10,000,000, Na=10,000, Nc=100” as in the above-described example, the number of parameters of the parameter group P is “100,000,000,000”, whereas the total number of parameters of the parameter groups C and PC is “1,001,000,000”. That is, by using the parameter groups C and PC instead of the parameter group P, the number of parameters can be reduced by the difference (here, 100-fold difference) between the order of the number of actions Na (here, 10⁴) and the order of the number of clusters Nc (here, 10²).

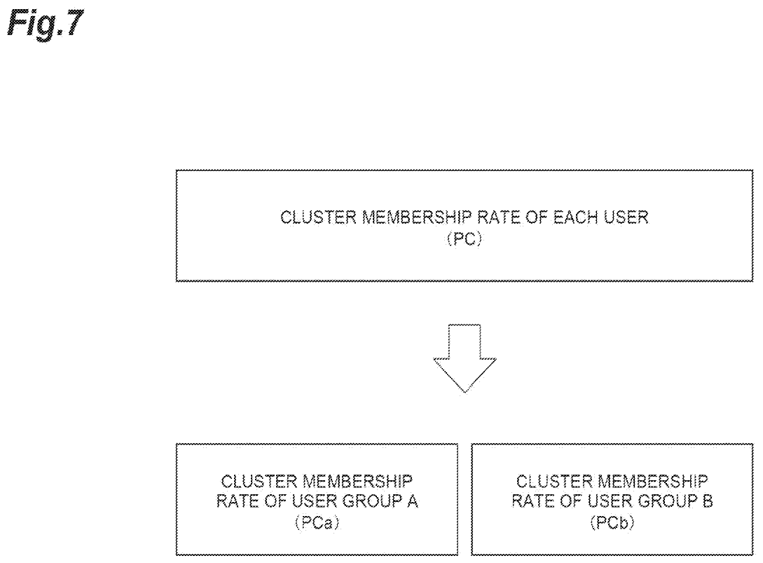

Next, the learning process performed by the learning unit 13 will be described in detail. For example, the learning unit 13 may perform a first learning process and a second learning process. More specifically, the learning unit 13 is configured to execute the second learning process after executing the first learning process. That is, the learning unit 13 does not learn the parameter group PC related to the cluster membership rate of each of the plurality of users at once, but divides the plurality of users into a user group A (first user group) and a user group B (second user group), and executes the learning process in stages. To be more specific, as shown in FIG. 7, the above-described parameter group PC is divided into a parameter group PCa relating to the cluster membership rate of the user group A and a parameter group PCb relating to the cluster membership rate of the user group B, and these parameter groups PCa and PCb are not learned simultaneously but learned stepwise.

(First Learning Process)

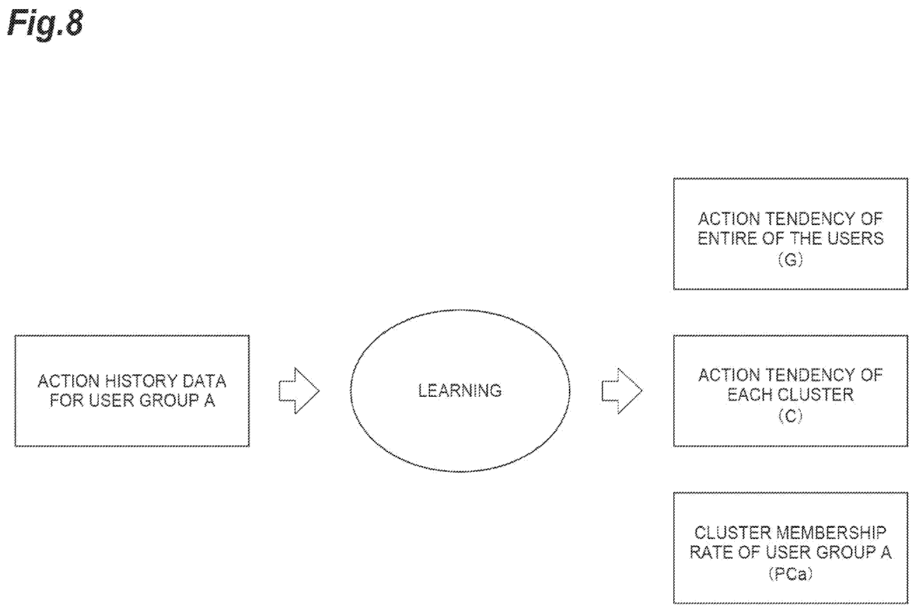

FIG. 8 is a diagram schematically illustrating the first learning process. As illustrated in FIG. 8, the first learning process is a process of learning a parameter group G related to an action tendency of entire users, a parameter group C related to an action tendency of each cluster, and a parameter group PCa related to a cluster membership rate of the user group A by using action history data for each user included in the user group A as training data. That is, the first learning unit 13A generates learned parameter groups G, C, and PCa from the action history data of some users (user group A).

As described above, the learning unit 13 execute the first learning process by using a learning (parameter estimation) algorithm such as a maximum likelihood estimation method or a Bayesian estimation method with respect to the machine learning model such as a neural network (a multilayer neural network, a hierarchical neural network, or the like) or a point process model, for example.

(Second Learning Process)

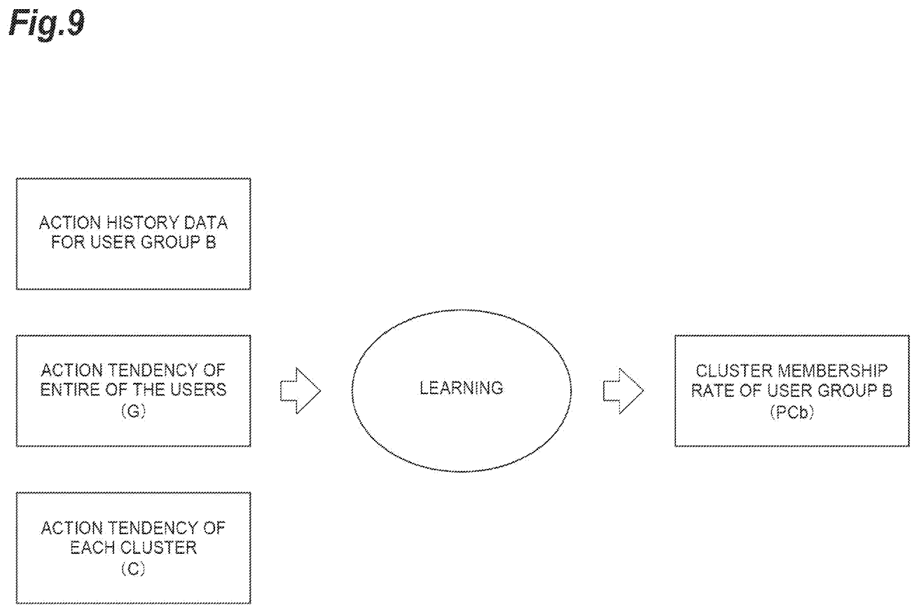

FIG. 9 is a diagram schematically illustrating the second learning process. As illustrated in FIG. 9, the second learning process is a process of learning the parameter group PCb related to a cluster membership rate of the user group B without changing the parameter groups G, C, and PCa learned by the first learning process by using the action history data for each user included in the user group B as training data. That is, the learning unit 13 treats the learned parameter groups G and C obtained by the first learning process as fixed parameters, and lean only the parameter group PCb. Since the user group B is independent of the user group A, the parameter group PCa related to the cluster membership rate of the user group A learned by the first learning process does not affect the learning of the parameter group PCb related to the cluster membership rate of the user group B. The second learning process is different from the first learning process only in the parameter group of the learning target, and the machine learning model and algorithm used in the second learning process are those used in the first learning process.

Next, an effect obtained by executing the first learning process and the second learning process in stages will be described. The amount of calculation required for each of the following cases is considered. One case is a case where the parameter groups G, C, and PC are simultaneously learned using the action history data of all the users (that is, both the user group A and the user group B) (hereinafter referred to as a “comparative example”). Another case is a case where the parameter groups G, C, and PCa are learned by the first learning process and then the parameter group PCb is learned by the second learning process as described above (hereinafter, referred to as “embodiment”). In the following description, the following notations are used.

O(G): unit calculation amount necessary for learning the parameter group G
O(PC): unit calculation amount necessary for learning the parameter group PC
O(PCa): unit calculation amount necessary for learning the parameter group PCa
O(PCb): unit calculation amount necessary for learning the parameter group PCb
O(C): unit calculation amount necessary for learning the parameter group C
N: total number of users
N_{A}: number of users of the user group A
N_{B}: number of users of the user group B
M: length of action history data for each user used as training data

Here, the length “M” of the action history data for each user used as training data is the number of records included in the action history data. Here, in order to simplify the description, it is assumed that the length of the action history data does not vary among users. In addition, O(G), O(PC), and O(C) defined above are calculation amounts (unit calculation amounts) necessary for learning using one training data. Therefore, the calculation amount required for learning a certain parameter group is represented by the product of the number of training data and the unit calculation amount of the parameter group. Further, it is assumed that the unit calculation amount O(G) of the parameter group G is sufficiently larger than the sum (O(PC)+O(C)) of the unit calculation amounts of the parameter groups PC and C. As an example, it is assumed that the following Equation 2 is satisfied. Here, it is assumed that the unit calculation amounts of the parameter groups PC, PCa, and PCb are the same. Specifically, it is assumed that the following Equation 3 is satisfied.

O(G)=1000×{O(PC)+O(C)} Equation 2

O(PC)≈O(PCa)≈O(PCb) Equation 3

On the above assumption, the calculation amount AC1 required for the comparative example is expressed by the following Equation 4.

AC1=M×N×{O(G)+O(PC)+O(C)} Equation 4

Here, when Equation 2 is applied to Equation 4, Equation 4 is transformed into Equation 5 below.

AC1=M×N×1001×{O(PC)+O(C)} Equation 5

On the other hand, the calculation amount AC2 required for the embodiment is expressed by the following Equation 6.

AC2=M×N_{A}×{O(G)+O(PCa)+O(C)}+M×N_{B}×O(PCb) Equation 6

The first term of Equation 6 represents the amount of calculation necessary for the first learning process, and the second term of Equation 6 represents the amount of calculation necessary for the second learning process. Here, when Equation 3 is applied to Equation 6, Equation 6 is transformed into Equation 7 below.

AC2=M×N_{A}×1001×{O(PC)+O(C)}+M×N_{B}×O(PC) Equation 7

In Equation 7, when the calculation amount (order) is considered, the first term is more dominant than the second term. In view of the above, the following Equation 8 is established between the calculation amount AC1 of the comparative example represented by Equation 5 and the calculation amount AC2 of the embodiment represented by Equation 7.

AC2/AC1≈N_{A}/N Equation 8

That is, according to the embodiment, the total calculation amount can be reduced to about N_{A} N as compared with the comparative example. For example, when the total number of users N is 10 million and the number of users N_{A} of the user group A is 100 thousand, the embodiment can perform the learning process with a calculation amount of 1/100 of that of the comparative example. That is, according to the embodiment, it is possible to effectively reduce the entire calculation amount by performing learning of the parameter group G related to the tendency of the entire user using as few samples (user group A) as possible. In addition, if the number of samples (the number of users) is too large when learning the tendency of the entire users, a problem of overfitting may occur. According to the embodiment, it is also possible to suppress the occurrence of such an overfitting problem.

The learned parameter groups G, C, PCa, and PCb learned by the learning unit 13 as described above are stored in the predictive model DB 14 which is a database storing the predictive model M.

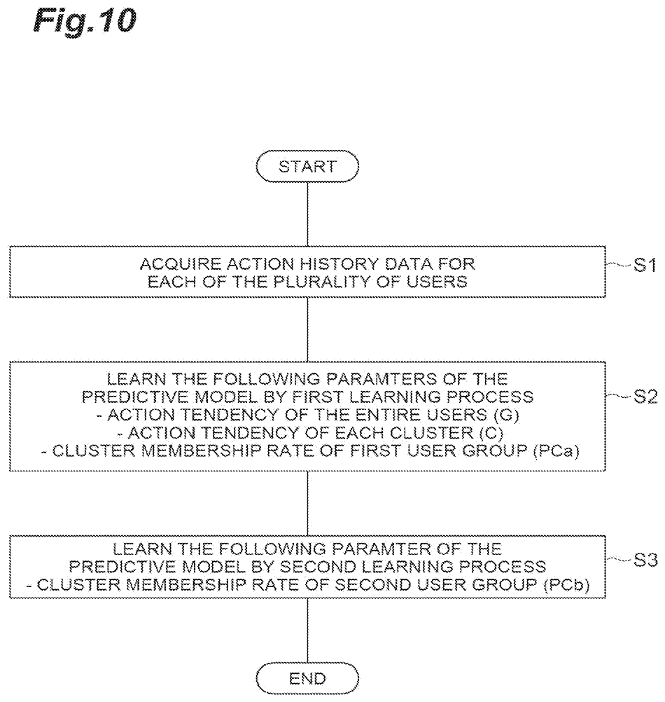

Next, an example of the operation of the learning apparatus 10 will be described with reference to the flowchart of FIG. 10.

In step S1, the acquisition unit 11 acquires action history data (see FIG. 2) for each of the plurality of users. The action history data acquired by the acquisition unit 11 are stored in the action history DB 12.

In step S2, the learning unit 13 executes the first learning process described above using the action history data for the first user group (user group A) as training data, thereby learning the parameter groups G, C, and PCa included in the predictive model M.

In step S3, the learning unit 13 learns the parameter group PCb included in the predictive model M by executing the above-described second learning process using the action history data for the second user group (user group B) as training data. At this time, the parameter groups G, C, and PCa learned in step S2 are treated as fixed parameters. That is, in the second learning process, these parameter groups G, C, and PCa are not changed.

The predictive model M learned in steps S2 and S3 (i.e., the parameter groups G, C, PCa, and PCb included in the predictive model M) is stored in the predictive model DB 14.

The learning apparatus 10 described above learns the parameter group PC (PCa, pCB) indicating the relationship between users and clusters and the parameter group C indicating the relationship between clusters and actions, instead of directly learning a probability that each of a plurality of users performs each of a plurality of actions (for example, the parameter group P related to action tendency of each user illustrated in FIG. 5). As described above, when the number of users is ten million, the number of actions is ten thousand, and the number of clusters is 100, the number of parameters of parameter group P is “100,000,000,000 (=the number of users (ten million)×the number of actions (ten thousand))”, whereas the number of parameters of parameter groups PC and C is “1,001,000,000 (=the number of users (ten million)×the number of clusters (100)+the number of clusters (100)×the number of actions (ten thousand))”. As described above, according to the learning apparatus 10, it is possible to effectively reduce the number of parameters to be learned. As a result, it is possible to effectively reduce calculation resources necessary for learning the predictive model M.

In addition, the parameter group C related to an action tendency of each cluster and the parameter group PC (PCa) related to a cluster membership rate of each user are simultaneously learned. As a result, the parameter groups C, PCa, and PCb are learned so that the action tendency of each user (that is, the tendency grasped from the action history data for each user) is reflected. According to this configuration, it is possible to perform flexible cluster setting (that is, setting of the action tendency of each cluster and the membership rate of the user with respect to each cluster) according to the action tendency of each user, compared to a case where the cluster (category) to which the user belongs is fixedly determined based on an arbitrary attribute of the user such as gender, age, occupation, or the like.

In addition, the predictive model M includes the parameter group G related to an action tendency of entire of the plurality of users, and the learning unit 13 learns the parameter group G together with the parameter group PC (in this embodiment, the parameter group PCa of some users (user group A)) and the parameter group C. In this case, it can be expected to perform prediction for user's action with high accuracy by the predictive model M including both the parameter group G related to the action tendency of the entire user and the parameter groups PC and C related to the action tendency of each user (that is, the action tendency of each user defined via a cluster). For example, by using the action tendency of the entire user indicated by the parameter group G as a reference and complementing the action tendency specific to each user deviating from the reference with the parameter groups PC and C, it is possible to accurately predict the action tendency of each user.

The learning unit 13 is configured to perform the first learning process (see FIG. 8) and then perform the second learning process (see FIG. 9). As described above, in the first learning process, by learning the parameter group G based on the training data (action history data) of some users (user group A), it is possible to perform learning with a smaller amount of calculation than in the case of learning based on the training data of all users. Further, for example, after the parameter groups G, C, and PCa are learned based on the action history data of the existing user group (user group A), a new user group (user group B) desired to be a prediction target may be added. In this case, after the new user group is added, only the additionally necessary parameter group (that is, parameter group PCb for the new user group) is learned without relearning the already learned parameter groups G, C, and PCa, thereby significantly reducing the calculation resources of the learning process.

Further, the learning unit 13 learns the predictive model M after fixing the number of clusters Nc in advance. In the above-described embodiment, as an example, the number of clusters Nc is fixed to “100”. In this case, the predictive model can be learned with less calculation resources than in the case where the number of clusters Nc is variable. More specifically, in a case where the number of clusters Nc is treated as a variable parameter, calculation resources increase by an amount corresponding to a process for determining the number of clusters Nc. By fixing the number of clusters Nc, such a calculation resource becomes unnecessary.

However, the number of clusters Nc may be treated as a variable parameter. That is, the learning unit 13 may learn the predictive model M by using the number of clusters Nc as a variable parameter. In this case, by adjusting the number of clusters Nc, it is possible to determine the optimum number of clusters from a viewpoint of the prediction accuracy of the predictive model M. For example, the learning unit 13 may learn a plurality of predictive models (for example, in predictive models M₁, . . . , Mₘ) having different numbers of clusters (for example, in different numbers of clusters Nc₁, . . . , Ncₘ), and may acquire an indicator for evaluating goodness of each of the plurality of predictive models M₁, . . . , Mₘ. Then, the learning unit 13 may determine the best predictive model M based on the respective indicator of the plurality of predictive models M₁, . . . , Mₘ.

An example of the indicator is an information criterion indicating that prediction (estimation) is more appropriate as the value is smaller. For example, the learning unit 13 can calculate an information criterion for each predictive model M₁, . . . , Mₘ by calculating penalty terms such as likelihoods and the number of parameters. The above-described likelihood and the number of parameters (that is, the number of parameters corresponding to the number of clusters) are calculated at the time of estimation (learning) of the parameter group. Therefore, the learning unit 13 can calculate the information criterion based on the likelihood and the number of parameters obtained at the end of the learning process. For example, when the Bayesian information criterion (BIC) is used as the information criterion, the learning unit 13 can calculate the BIC by using an expression “BIC=−2×ln(L)+k×ln(n)”. In the above equation, L is a likelihood, k is the number of parameters, and n is the size (the number of records) of training data (action history data). The learning unit 13 can determine a predictive model having the smallest information criterion among the plurality of predictive models M₁, . . . , Mₘ as the predictive model M to be finally adopted. That is, it is possible to select (determine) the predictive model M which is determined to be the best on the basis of the each result (each predictive model M₁, . . . , Mₘ obtained as a result of learning) learned using a plurality of cluster numbers Nc₁, . . . , Ncₘ different from each other. Therefore, it is possible to generate (determine) the predictive model M with high prediction accuracy in a case where an appropriate number of clusters is not known in advance.

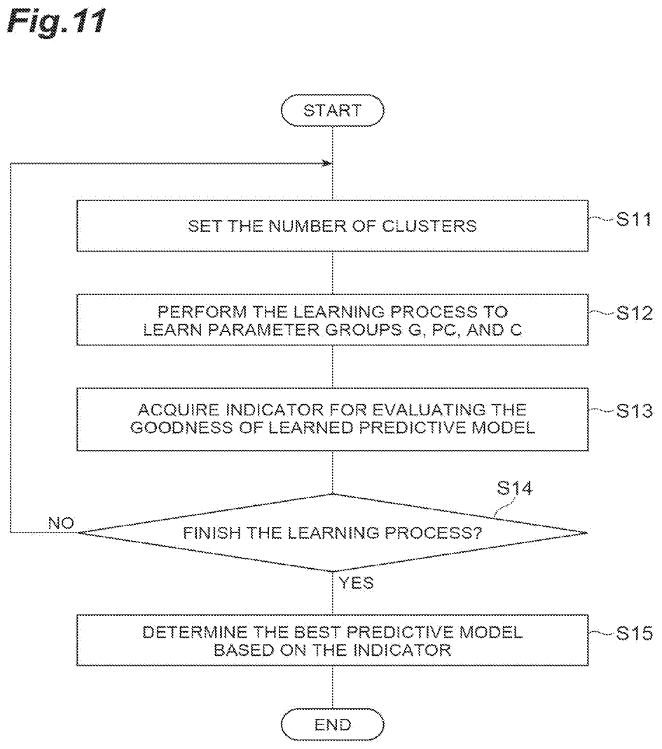

With reference to FIG. 11, an example of a processing procedure of a process of learning the parameter groups G, PC, and C using the cluster number Nc as a variable parameter will be described. Here, a case where the parameter group PC is learned without dividing the plurality of users into the user groups A and B will be described. When the first learning process and the second learning process are performed by dividing the plurality of users into the user groups A and B as in the above-described embodiment, the “learning process” and “parameter groups G, PC, and C” in step S12 are replaced with the “first learning process” and “parameter groups G, PCa, and C”, respectively.

In step S11, the learning unit 13 sets the number of clusters (as initial setting, Nc₁ is set). In step S12, the learning unit 13 performs the above-described learning process using the number of clusters Nc set in step S1. As a result, the learned parameter groups G, PC, and C are obtained. In step S13, the learning unit 13 acquires the indicator (for example, the above-described information criterion) for evaluating the goodness of the predictive model M₁ including the learned parameter groups G, PC, and C obtained in step S12. Subsequently, the learning unit 13 repeats the processing of steps S11 to S13 until the processing for each of a plurality of predetermined cluster numbers Nc₁, . . . , Ncₘ is completed (step S14: NO). Then, after the processing for each of the plurality of cluster numbers Nc₁, . . . , Ncₘ is completed (step S14: YES), the learning unit 13 executes step S15. In step S15, the learning unit 13 determines the best predictive model M based on the indicator of the plurality of predictive models M₁, . . . , Mₘ obtained for each of the plurality of cluster numbers Nc₁, . . . , Ncₘ.

Here, an example in which the creator (operator) of the predictive model M determines the plurality of cluster numbers Nc₁, . . . , Ncₘ in advance has been described, but the cluster number may be determined as follows. For example, the learning unit 13 may start the number of clusters from a predetermined initial value (for example, 1), perform learning of the predictive model and acquisition of the indicator, and perform learning of the predictive model and acquisition of the indicator while changing (for example, incrementing) the number of clusters until an indicator satisfying a predetermined condition (for example, an information criterion equal to or less than a predetermined threshold) is obtained. According to such processing, it is not necessary to determine a plurality of cluster numbers Nc₁, . . . , Ncₘ in advance. In addition, it is possible to prevent the occurrence of a problem that the optimum number of clusters does not exist in the plurality of predetermined numbers of clusters Nc₁, . . . , Ncₘ. For example, in a case where the optimal number of clusters is “100”, if the plurality of numbers of clusters Nc₁, . . . , Ncₘ are set in the range of “3 to 20”, the predictive model M corresponding to the optimal number of clusters cannot be obtained. As described above, it is possible to prevent the above-described problem from occurring by executing the learning process using the fact that an indicator satisfying a predetermined condition is obtained as an end condition.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but not limited thereto.

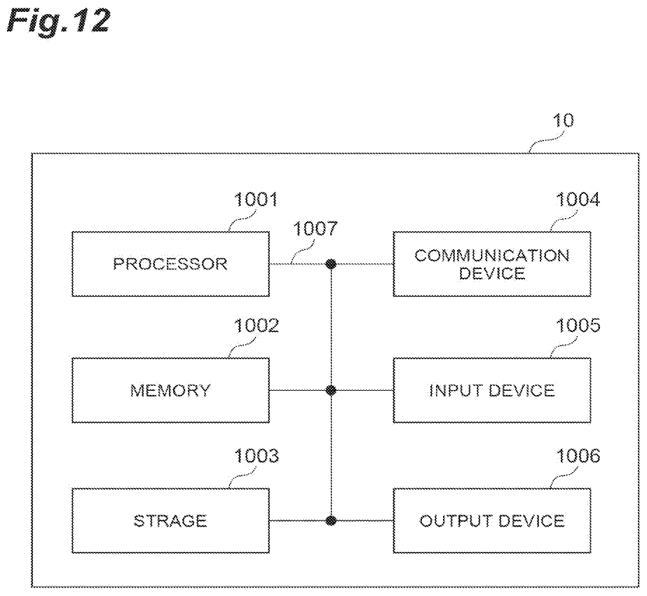

For example, the learning apparatus 10 according to an embodiment of the present invention may function as a computer that performs an information processing method of the present disclosure. FIG. 12 is a diagram illustrating an example of a hardware configuration of the learning apparatus 10 according to the embodiment of the present disclosure. The learning apparatus 10 described above may be physically configured as a computer device including a processor 1001, a memory 1002, a storage 1003, a communication device 1004, an input device 1005, an output device 1006, a bus 1007, and the like.

In the following description, the term “device” can be referred to as a circuit, a device, a unit, or the like. The hardware configuration of the learning apparatus 10 may include one or a plurality of devices illustrated in FIG. 12, or may be configured without including some of the devices.

Each function in the learning apparatus 10 is realized by loading predetermined software (a program) into hardware such as the processor 1001 or the memory 1002 so that the processor 1001 performs computation to control communication that is performed by the communication device 1004 or control at least one of reading and writing of data in the memory 1002 and the storage 1003.

The processor 1001, for example, operates an operating system to control the entire computer. The processor 1001 may be configured as a central processing unit (CPU) including an interface with peripheral devices, a control device, a computation device, a register, and the like.

Further, the processor 1001 reads a program (program code), a software module, data, or the like from at one of the storage 1003 and the communication device 1004 into the memory 1002 and executes various processes according to the program, the software module, the data, or the like. As the program, a program for causing the computer to execute at least some of the operations described in the above-described embodiment may be used. For example, the learning unit 13 may be realized by a control program that is stored in the memory 1002 and operated on the processor 1001, and other functional blocks may be realized similarly. Although the case in which the various processes described above are executed by one processor 1001 has been described, the processes may be executed simultaneously or sequentially by two or more processors 1001. The processor 1001 may be realized using one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), software modules, and the like in order to implement the communication control method according to the embodiment of the present disclosure.

The storage 1003 is a computer-readable recording medium and may also be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, the respective devices such as the processor 1001 and the memory 1002 are connected by the bus 1007 for information communication. The bus 1007 may be configured using a single bus or may be configured using buses different between the devices.

Further, the learning apparatus 10 may include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be implemented by at least one of these pieces of hardware.

Although the present embodiment has been described in detail above, it is apparent to those skilled in the art that the present embodiment is not limited to the embodiments described in the present disclosure. The present embodiment can be implemented as a modification and change aspect without departing from the spirit and scope of the present invention determined by description of the claims. Accordingly, the description of the present disclosure is intended for the purpose of illustration and does not have any restrictive meaning with respect to the present embodiment.

A process procedure, a sequence, a flowchart, and the like in each aspect/embodiment described in the present disclosure may be in a different order unless inconsistency arises. For example, for the method described in the present disclosure, elements of various steps are presented in an exemplified order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to be made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless whether the software is called software, firmware, middleware, microcode, or hardware description language or called another name.

Further, software, instructions, information, and the like may be transmitted and received via a transmission medium. For example, when software is transmitted from a website, a server, or another remote source using wired technology (a coaxial cable, an optical fiber cable, a twisted pair, a digital subscriber line (DSL), or the like) and wireless technology (infrared rays, microwaves, or the like), at least one of the wired technology and the wireless technology is included in a definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or an arbitrary combination of them.

Further, the information, parameters, and the like described in the present disclosure may be expressed using an absolute value, may be expressed using a relative value from a predetermined value, or may be expressed using another corresponding information.

Names used for the above-described parameters are not limited names in any way. Further, equations or the like using these parameters may be different from those explicitly disclosed in the present disclosure. Since various information elements can be identified by any suitable names, the various names assigned to these various information elements are not limited names in any way.

The description “based on” used in the present disclosure does not mean “based only on” unless otherwise noted. In other words, the description “based on” means both of “based only on” and “based at least on”.

Any reference to elements using designations such as “first,” “second,” or the like used in the present disclosure does not generally limit the quantity or order of those elements. These designations may be used in the present disclosure as a convenient way for distinguishing between two or more elements. Thus, the reference to the first and second elements does not mean that only two elements can be adopted there or that the first element has to precede the second element in some way.

When “include”, “including” and transformation of them are used in the present disclosure, these terms are intended to be comprehensive like the term “comprising”. Further, the term “or” used in the present disclosure is intended not to be exclusive OR.

In the present disclosure, for example, when articles such as a, an, and the in English are added by translation, the present disclosure may include that nouns following these articles are plural.

In the present disclosure, a sentence “A and B are different” may mean that “A and B are different from each other”. The sentence may mean that “each of A and B is different from C”. Terms such as “separate”, “coupled”, and the like may also be interpreted, similar to “different”.

### REFERENCE SIGNS LIST

10 learning apparatus
11 acquisition unit
12 action history DB
13 learning unit
14 predictive model DB
C parameter group (second parameter group)
G parameter group (third parameter group)
PC, PCa, PCb parameter group (first parameter group)

1. A learning apparatus comprising:
an acquisition unit configured to acquire action history data indicating action history for each of a plurality of users; and
a learning unit configured to learn a first parameter group and a second parameter group included in a predictive model for predicting an action of each of the plurality of users by using the action history data as training data,
wherein the first parameter group is a parameter group related to a membership rate of each user for each of a plurality of clusters, and
the second parameter group is a parameter group related to an action tendency of each cluster for each of a plurality of actions.

2. The learning apparatus according to claim 1,
wherein the predictive model includes a third parameter group related to an action tendency of entire of the plurality of users, and
the learning unit is configured to learn the third parameter group together with the first parameter group and the second parameter group.

3. The learning apparatus according to claim 2,
wherein the learning unit is configured to perform a second learning process after performing a first learning process,
the first learning process is a process of learning the first parameter group, the second parameter group, and the third parameter group for a first user group by using the action history data for the first user group as training data, and
the second learning process is a process of learning the first parameter group for a second user group that is different from the first user group by using the action history data for the second user group as training data without changing the first parameter group, the second parameter group, and the third parameter group for the first user group learned by the first learning process.

4. The learning apparatus according to claim 2 or 3,
wherein the action history data for each of the users includes a plurality of records in which a time, a place, and information indicating an action performed by the user at the time and the place are associated with each other, and
the predictive model is a model that outputs a probability that each of the plurality of actions is performed by a prediction target user at prediction target time based on the first parameter group, the parameter group related to the prediction target user included in the second parameter group, and the third parameter group when recent action history data for the prediction target user and the prediction target time are given as input data.

5. The learning apparatus according to claim 2 or 3,
wherein the action history data for each of the users includes a plurality of records in which a time, a place, and information indicating an action performed by the user at the time and the place are associated with each other, and
the predictive model is a model that outputs information in which a probability and a time at which a prediction target action is performed by a prediction target user are associated with each other based on the first parameter group, the parameter group related to the prediction target user included in the second parameter group, and the third parameter group when recent action history data for the prediction target user and information indicating the prediction target action are given as input data.

6. The learning apparatus according to claim 1,
wherein the learning unit is configured to learn the predictive model after fixing a number of clusters in advance.

7. The learning apparatus according to claim 1,
wherein the learning unit is configured to learn the predictive model by using a number of clusters as a variable parameter.

8. The learning apparatus according to claim 7,
wherein the learning unit is configured to:
learn a plurality of predictive models having mutually different numbers of clusters, and acquire an indicator for evaluating goodness of each of the plurality of predictive models; and
determine a best predictive model based on the indicator for each of the plurality of predictive models.
